(19) United States
(12) Patent Application Publication
(10) Pub. No.: US 2014/0188336 A1
(43) Pub. Date: Jul. 3, 2014

(54) VIBRATION DAMPING FOR A CONVERTIBLE VEHICLE

(71) Applicant: GM Global Technology Operations LLC, (US)

(72) Inventors: SHAWN G. QUINN, GRAND BLANC, MI (US); CHRISTOPHER A. STIRLEN, MILFORD, MI (US); MARK A. STEBBINS, BLOOMFIELD HILLS, MI (US)

(73) Assignee: GM GLOBAL TECHNOLOGY OPERATIONS LLC, Detroit, MI (US)

(21) Appl. No.: 13/731,848

(22) Filed: Dec. 31, 2012

(51) Int. Cl. F16F 9/53

(52) U.S. Cl. CPC F16F 9/535
USPC 701/36

(57) ABSTRACT

Methods and apparatus are provided for attenuating vibrations in the header of a convertible vehicle. The apparatus includes a fluid damper configured to be coupled to a header of a convertible vehicle and an accelerometer for sensing vibrations in the header and providing a signal to adjust the fluid damper thereby attenuating the vibrations. A method is provided which includes receiving a signal indicating a vibration in a header of a convertible vehicle and adjusting a fluid damper coupled to the header in response to the signal thereby attenuating the vibration.

### TECHNICAL FIELD

The technical field generally relates to vibration damping, and more particularly, to a system and method for controlling/regulating an electronically controlled damping system in a convertible vehicle.

### BACKGROUND

Convertible motor vehicles have a roof that can be manually or automatically transferred from a closed position to an open position (and vice versa). For example, some convertible vehicles are equipped with a folding roof that consists of a flexible material (or “soft-top”) which folds into a storage area when the roof is in the open position. Other convertible vehicles have several roof segments (or “retractable hardtop”), in which the roof segments are folded on top of one another in the open position and the stack of segments can be stowed, for example, in the trunk or behind the rear seat.

With respect to convertible vehicles, it is known that the driving dynamics of the vehicle change depending on whether the vehicle roof is in its open position or in its closed position. The main reasons for this variability in the driving dynamics are the changed bending and torsional rigidity of the vehicle body, as well as a shift of the vehicle masses that is caused by the changed position of the vehicle roof. For example, when the vehicle roof is opened, the front header that supports the windshield of the convertible vehicle is no longer supported by the retracted roof. In this case, interaction between the vehicle suspension system and road conditions may cause lateral vibrations (or shake) in the vehicle front header that operators of the vehicle may find objectionable.

Conventionally, passive vibration absorbers have been attached to the header in an attempt to attenuate (absorb) the unwanted vibrations. However, lateral shake is a non-linear response that limits the effectiveness of passive absorbers since passive absorbers are tuned to a predetermined mass for selected driving conditions.

Accordingly, it is desirable to provide a vibration attenuation system for convertible vehicles that is effective at attenuating lateral vibrations in the header. In addition, it is desirable to have such a system be closed loop so as to be responsive to the non-linear nature of lateral shake. Furthermore, other desirable features and characteristics of the present invention will become apparent from the subsequent detailed description and the appended claims, taken in conjunction with the accompanying drawings and the foregoing technical field and background.

### SUMMARY

An apparatus is provided for attenuating vibrations in the header of a convertible vehicle. In one embodiment, the apparatus includes a fluid damper configured to be coupled to a header of a convertible vehicle and an accelerometer for sensing vibrations in the header and providing a signal to adjust the fluid damper thereby attenuating the vibrations.

A method is provided for attenuating vibrations in the header of a convertible vehicle. In one embodiment, the method includes receiving a signal indicating a vibration in a header of a convertible vehicle and adjusting a fluid damper coupled to the header in response to the signal thereby attenuating the vibration.

### DESCRIPTION OF THE DRAWINGS

The exemplary embodiments will hereinafter be described in conjunction with the following drawing figures, wherein like numerals denote like elements, and wherein:

FIG. 1 is top plan view of a convertible vehicle in accordance with an embodiment;

FIG. 2 is cross-sectional view of the fluid damper of FIG. 1 in accordance with a first embodiment;

FIG. 3 is cross-sectional view of the fluid damper of FIG. 1 in accordance with another embodiment; and

FIG. 4 is flow diagram illustrating a method in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

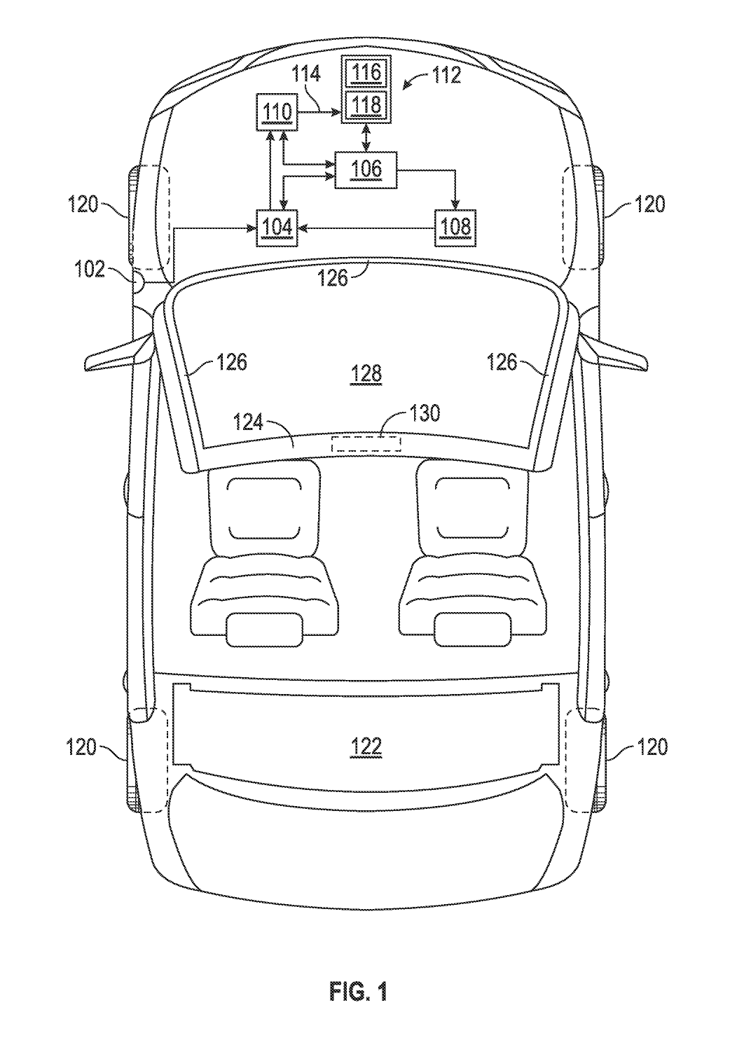

Finally, for the sake of brevity, conventional techniques and components related to vehicle electrical and mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention. It should also be understood that FIGS. 1-3 are merely illustrative and may not be drawn to scale.

FIG. 1 is a simplified schematic representation of an embodiment of a convertible vehicle 100 according to exemplary embodiments. Although the vehicle 100 is illustrated as a purely electric vehicle, the techniques and concepts described herein are also applicable to hybrid electric vehicles or vehicles employing internal combustion engines. The vehicle 100 may be two-wheel drive (2WD), four-wheel drive (4WD), or all-wheel drive (AWD). In internal combustion or hybrid electric vehicle embodiments, the convertible vehicle 100 may also incorporate any one of, or combination of, a number of different types of engines, such as, for example, a gasoline or diesel fueled combustion engine, a flex fuel vehicle (FFV) engine (i.e., using a mixture of gasoline and alcohol), a gaseous compound (e.g., hydrogen and/or natural gas) fueled engine in addition to an electric motor.

The illustrated embodiment of the convertible vehicle 100 includes, without limitation: a plug-in charging port 102 coupled to an energy storage system 104; a control module 106 coupled to a generator 108 for charging the energy storage system 104; and an inverter 110 coupled to the energy storage system 104 for providing AC power to a powertrain 112 via a cable 114. The powertrain 112 includes an electric motor 116 and a transmission 118 for driving wheels 120 to propel the convertible vehicle 100.

The plug-in charging port 102 may be configured as any suitable charging interface, and in one embodiment, comprises a charging receptacle compatible with the J1772 standard, which receives a charging cable with compatible plug (not shown). The energy storage system 104 may be realized as a rechargeable battery pack having a single battery module or any number of individual battery cells operatively interconnected (e.g., in series or in parallel), to supply electrical energy. A variety of battery chemistries may be employed within the energy storage system 104 such as, lead-acid, lithium-ion, nickel-cadmium, nickel-metal hydride, etc.

The control module 106 may include any type of processing element or vehicle controller, and may be equipped with nonvolatile memory, random access memory (RAM), discrete and analog input/output (I/O), a central processing unit, and/or communications interfaces for networking within a vehicular communications network. The control module 106 is coupled to the energy storage system 104, the generator 108, the inverter 110 and the powertrain 112 and controls the flow of electrical energy between the these modules depending on a required power command, the state of charge of the energy storage system 104, etc.

As noted above, in hybrid-electric embodiments, the powertrain 112 includes an electric motor 116 and a transmission 118 configured within a powertrain housing. The electric motor 16 includes a rotor and stator (not shown) operatively connected via the transmission 118 to at least one of the wheels 120 to transfer torque thereto for propelling the vehicle 100. It will be appreciated that in hybrid-electric embodiments, the powertrain 112 may be implemented as a series hybrid-electric powertrain or as a parallel hybrid-electric powertrain.

As illustrated in FIG. 1, the convertible vehicle 100 is shown with the roof in the open position with the roof stored in a storage area 122. A front header 124 forms part of a frame 126 that supports the windshield 128 and various amenities such as sun visors, etc. According to various embodiments, the header 124 of the convertible vehicle 100 is equipped with a fluid damper 130. As will be discussed in more detail below, the fluid damper 130 is a dynamically adjustable fluid damper providing an electrically controlled mass that attenuates (absorbs) vibrations in the header 124 such as lateral vibrations. Sensors may be integrated with the fluid damper 130 or coupled to the header 124 to provide a signal indicating the vibrations are present in the header. In this way, a closed-loop control system is provided to achieve active and dynamic vibration damping.

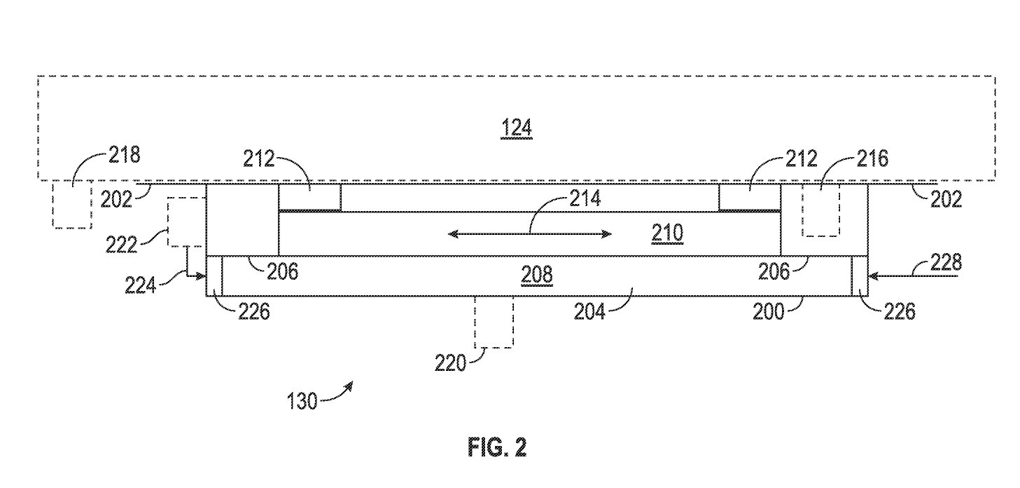

FIG. 2 is a cross-sectional view of an exemplary embodiment of an adjustable fluid damper 130. The illustrated embodiment comprises a Magneto-Rheological damper contained in a housing 200 that is coupled to the header 124 via mounting brackets 202. A reservoir 204 is defined within the housing 200 by a diaphragm 206. The reservoir 204 contains a Magneto-Rheological fluid 208 that has the property of changing its viscosity responsive to an electromagnetic field applied across the reservoir or an electric current passing through the Magneto-Rheological fluid 208. In some embodiments, the Magneto-Rheological fluid 208 consists of an approximately twenty percent iron fluid (e.g., FE 20% by volume fraction) that will undergo a viscosity change responsive to an electric field or current. Above the diaphragm 206, a base mass 210 is mounted to the upper portion of the housing 200 by mounts 212. In a non-limiting embodiment, the base mass 210 has a mass in the range of 0.5-1.0 kilograms. Together the base mass 210 and the Magneto-Rheological fluid 208 provide an electrically adjustable (or tunable) mass effective at attenuating (absorbing) vibrations in the header, including lateral vibrations (indicated by the double arrow 214) in the exemplary range of 11-22 Hertz. This affords an advantage over passive absorbers in that the overall size (or “package”) of the fluid damper is reduced.

According to various embodiments, a closed-loop control system is provided for the fluid damper 130 by incorporating sensors or accelerometers to provide a signal for adjusting the fluid damper 130. In some embodiments, the sensor 216 is integrated within the housing 200. In some embodiments, the sensor 218 is coupled to the header 124. In some embodiments, the sensor 220 can be placed on the housing 200 at an external bottom portion. In some embodiments, the sensor 222 can be placed on the housing 200 at an external side portion. Regardless of the placement of the sensor 222, a signal 224 is provided to the fluid damper 130 causing the Magneto-Rheological fluid 208 to change its viscosity. In some embodiments connections 226 comprise electromagnets within the reservoir 204 that apply an electromagnetic field across the Magneto-Rheological fluid 208 to change its viscosity. In some embodiments, connections 226 comprise electrodes for passing a current through the Magneto-Rheological fluid 208 to change its viscosity. Additionally or alternately, the fluid damper 130 could be controlled (or also controlled) by the control module (106 of FIG. 1) via connection 228. In this way, factors such as the speed of the convertible vehicle 100 or the revolutions (e.g., revolution per minute (RPM)) of the engine (116 of FIG. 1) or transmission (118 of FIG. 1) can be taken into account for adjusting the fluid damper 130.

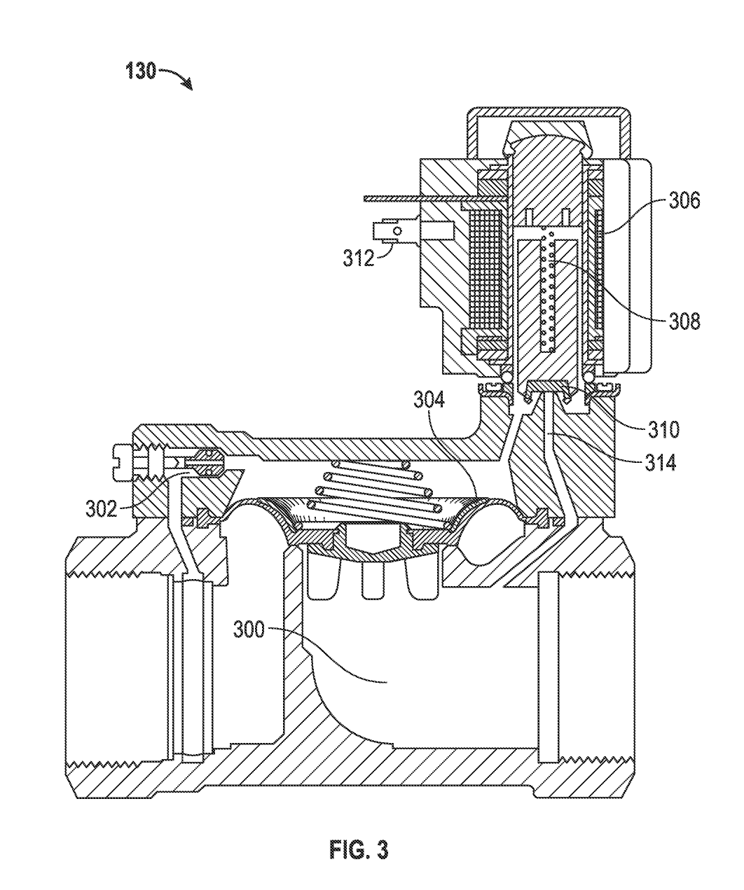

FIG. 3 is a cross-sectional view of another exemplary embodiment of an adjustable fluid damper 130. As will be appreciated, the adjustable fluid damper 130 can be operably fastened to the header via a mounting bracket (not shown in FIG. 3) and using adhesives, mechanical fasteners, riveting, welding, etc. The illustrated embodiment comprises a servo-controlled fluid damper comprising a main orifice 300 and an equalizing orifice 302 separated by a diaphragm 304. A coil 306, armature spring 308 and valve plate 310 control how much hydrolytic fluid passes from a port 312 into the main orifice 300 via a pilot orifice 314. By controlling the volume of hydraulic fluid in the main orifice 300, the mass of the servo-controlled fluid damper is adjusted thereby attenuating vibrations in the header (124 of FIG. 1) of the convertible vehicle (100 of FIG. 1).

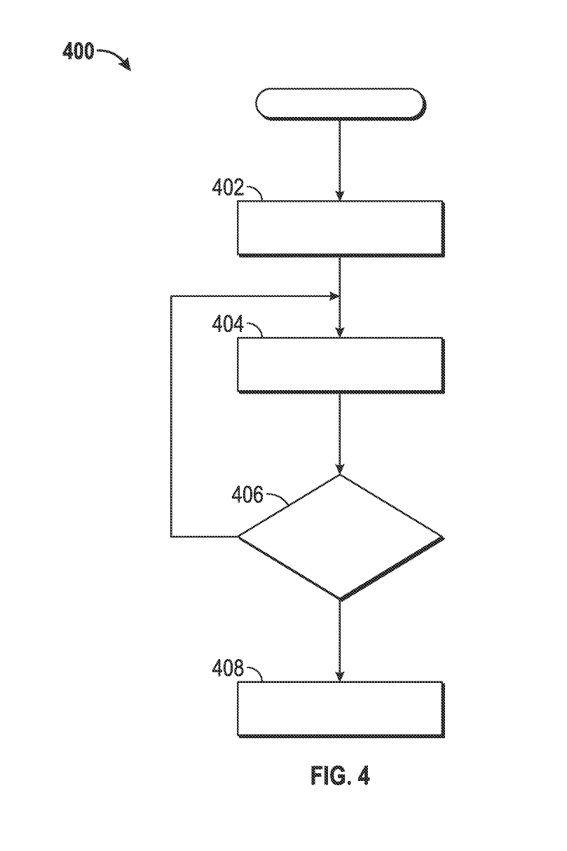

FIG. 4 illustrates a flow diagram useful for understanding the method 400 for attenuating vibrations in the header (124 of FIG. 1) of the convertible vehicle (100 of FIG. 1). The various tasks performed in connection with the method 400 of FIG. 4 may be performed by software, hardware, firmware, or any combination thereof. For illustrative purposes, the following description of the method 400 of FIG. 4 may refer to elements mentioned above in connection with FIGS. 1-3. In practice, portions of the method of FIG. 4 may be performed by different elements of the described system. It should also be appreciated that the method of FIG. 4 may include any number of additional or alternative tasks and that the method of FIG. 4 may be incorporated into a more comprehensive procedure or process having additional functionality not described in detail herein. Moreover, one or more of the tasks shown in FIG. 4 could be omitted from an embodiment of the method 400 of FIG. 4 as long as the intended overall functionality remains intact.

The routine (method 400) begins in step 402 where a signal (224 or 228 of FIG. 2) is received indicating that a vibration exists in the header (124 of FIG. 1) of the convertible vehicle (100 of FIG. 1). The signal can be provided by sensors or accelerometers position in various positions, some of which were described above in connection with FIG. 2. Additionally or alternately, the signal could be provided by the control module (106 of FIG. 1). In step 404, the fluid damper (130 of FIG. 2) is adjusted in response to this signal effectively adjusting its mass (the collective mass provided by the base mass 210 and the viscosity of the Magneto-Rheological fluid 208) to attenuate (absorb) some or all of the vibration. This may be achieved by varying an electromagnetic field across the Magneto-Rheological fluid 208 or modifying a current passing through the Magneto-Rheological fluid 208. In step 406, it may be determined whether the vibration(s) have been effectively attenuated. In some embodiments, this is determined by the continued reception or absence of the signal. In some embodiments, the signal (if still present) is compared to a threshold to determine if the vibration(s) have been attenuated below a level perceivable by the operator of the vehicle 100. If so, the routine ends (step 408) until the signal is received yet again in step 402. If not, the routine returns to step 404 for continued adjustment of the fluid damper 130. In this way, a closed-loop control system is provided for dynamic and continuous attenuation of vibrations.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

1. A method, comprising:
receiving a signal indicating a vibration in a header of a convertible vehicle; and
adjusting a fluid damper coupled to the header in response to the signal, thereby attenuating the vibration.

2. The method of claim 1, further comprising sensing the vibration via an accelerometer, the accelerometer providing the signal.

3. The method of claim 1, further comprising providing the signal from a control module to adjust the fluid damper.

4. The method of claim 3, further comprising determining a speed of the convertible vehicle and providing the signal from the control module based upon the speed of the convertible vehicle.

5. The method of claim 3, further comprising determining engine revolutions of an engine of the convertible vehicle and providing the signal from the control module based upon the engine revolutions.

6. The method of claim 1, wherein adjusting the fluid damper comprises varying an electromagnetic field applied to a Magneto-Rheological fluid within the fluid damper.

7. The method of claim 1, wherein adjusting the fluid damper comprises varying hydraulic fluid within the fluid damper via a servo actuated value.

8. The method of claim 1, wherein adjusting the fluid damper attenuates lateral vibrations in the header of the convertible vehicle in a 11-22 Hertz range.

9. A system, comprising:
a fluid damper configured to be coupled to a header of a convertible vehicle; and
an accelerometer for sensing vibrations in the header and providing a signal to adjust the fluid damper thereby attenuating the vibrations.

10. The system of claim 9, wherein the fluid damper comprises a Magneto-Rheological fluid damper.

11. The system of claim 10, wherein the Magneto-Rheological fluid damper further comprises:
a mass configured to be a base tuning element;
a Magneto-Rheological fluid;
a diaphragm between the mass the Magneto-Rheological fluid; and
an electromagnetic field source providing a varying electromagnetic field to the Magneto-Rheological fluid responsive to the signal.

12. The system of claim 11, wherein the mass is in a range of 0.5-1.0 kilograms.

13. The system of claim 11, wherein the Magneto-Rheological fluid comprises approximately twenty percent iron.

14. The convertible vehicle of claim 11, wherein the fluid damper comprises servo controlled hydrolytic fluid damper.

15. A convertible vehicle, comprising:
an engine;
a header coupled to a frame supporting a windshield of the convertible vehicle;
a sensor for providing a signal indicating vibrations in the header; and
a fluid damper mounted to the header, the fluid damper being adjustable responsive to the signal thereby attenuating the vibrations.

16. The convertible vehicle of claim 15, wherein the sensor comprises an accelerometer for sensing lateral vibrations in the header in a range of 11-22 Hertz range.

17. The convertible vehicle of claim 15, wherein the fluid damper comprises a servo controlled hydrolytic fluid damper.

18. The convertible vehicle of claim 15, wherein the fluid damper comprises a Magneto-Rheological fluid damper.

19. The convertible vehicle of claim 15, which includes a control module coupled to the engine and wherein the control module is configured to determine a speed of the convertible vehicle and provide another signal to adjust the fluid damper based upon the speed of the convertible vehicle.

20. The convertible vehicle of claim 15, which includes a control module coupled to the engine and wherein the control module is configured to determine engine revolutions of the engine and provide another signal to adjust the fluid damper based upon the engine revolutions.
